(19) United States
(12) Patent Application Publication
(10) Pub. No.: US 2005/0252359 A1
(43) Pub. Date: Nov. 17, 2005

(54) Guitar teacher

(76) Inventor: Randy Mitchell Cook, Honolulu, HI (US)

Correspondence Address: RANDY M. COOK, 6227-A KAWAI HAE PL., HONOLULU, HI, 96825, US

(21) Appl. No.: 10/846,885

(22) Filed: May 17, 2004

(51) Int. Cl. G10H 7/00

(52) U.S. Cl. 84/464 A

(57) ABSTRACT

The Guitar Teacher is completely new in that it is the first invention to ever use a (LCD) Liquid Crystal Display panel and a computer in conjunction with a guitar, neck and fret board to display the notes and fingerings for guitar chords, scales and/or songs, right on the fret-board of the guitar itself.

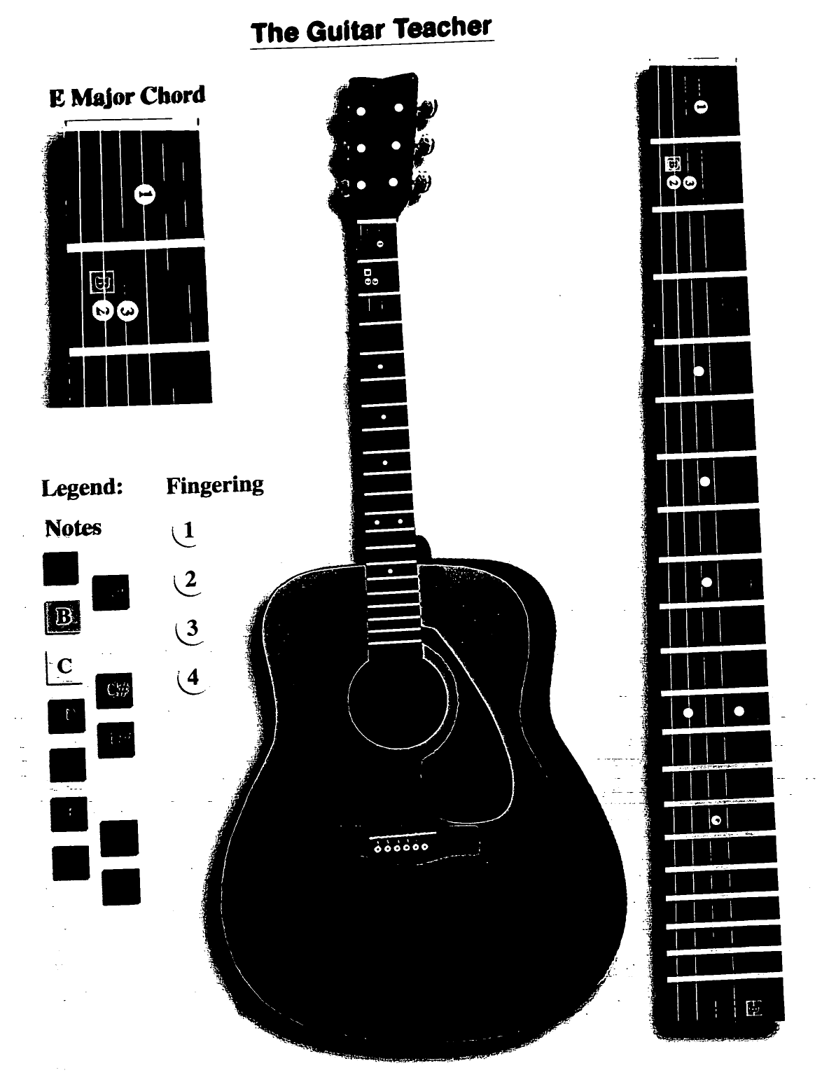

### BACKGROUND OF THE INVENTION

The Guitar Teacher pertains to a method and apparatus designed to teach a student how to play Guitar quickly and easily with a higher level of effectiveness and mental absorption by displaying the notes and fingering for chords, scales and/or songs directly under the strings and right on the fret-board of the Guitar itself.

### BRIEF SUMMARY OF THE INVENTION

By utilizing a specially designed (LCD) Liquid Crystal Display panel that is built into, and is visible through, the Guitar's clear, high density, polymer fret-board, a user can now see the notes and fingering for chords, scales and/or songs, right on the fret-board of the Guitar. A computer/keypad (resembling a television remote control) is the remote, wireless entry control where the user can enter the chords, scales, and/or songs to be displayed. This remote entry device can also be attached into the body of the Guitar.

### DETAILED DESCRIPTION OF THE INVENTION

The Guitar Teacher is a regular guitar (acoustic or electric) with the exception of the neck's fret board having a built in LCD panel. The Guitar Teacher system is setup on the methodology of guitar tablature. The numbers 1 through 4 correspond to the four fingers on the fret hand with the index finger being number 1. The student enters a chord, scale, and/or song on the keypad and the fret board of the Guitar lights up displaying the notes (color coded) and the proper finger placement (number coded) directly under the corresponding string and fret. The student then simply places their fingers on those points on the fret board and then strums or picks the strings. The ability to display all the notes and fingerings of the guitar directly on the fret-board will tremendously increase the speed and quality of the learning process. This system allows for practically endless flexibility and possibilities with regard to what is taught and how it is taught according to how it is displayed.

Detailed Description of the Invention (cont.)

The system will require proprietary software and programming that will use flash card memory to input songs and software to the guitars internal memory.

1. What I claim as my invention is the use of a (LCD) Liquid Crystal Display panel and a computer in conjunction with a guitar to display the notes and fingerings for guitar chords, scales and/or songs, right on the fret-board of the Guitar itself. Thus teaching the student how to play Guitar quickly and easily with a higher level of effectiveness and mental absorption.
